(19) United States
(12) Patent Application Publication
(10) Pub. No.: US 2026/0311135 A1
(43) Pub. Date: Oct. 8, 2026

(54) DATA ROLL UP

(71) Applicant: Lucid Software, Inc., South Jordan, UT (US)

(72) Inventors: Benjamin Dilts, South Jordan, UT (US); Ryan Stringham, South Jordan, UT (US); Richard Shurtz, South Jordan, UT (US); Joseph Stack, South Jordan, UT (US)

(21) Appl. No.: 19/637,814

(22) Filed: Apr. 2, 2026

Related U.S. Application Data
(60) Provisional application No. 63/782,323, filed on Apr. 2, 2025.

(51) Int. Cl. G06Q 10/10

(52) U.S. Cl. CPC G06Q 10/103

(57) ABSTRACT

In an example, a computer-implemented method to roll up data from elements on a canvas includes providing a blueprint to a plurality of teams of an organization. The blueprint includes one or more roll-up shapes soliciting user inputs. The method includes receiving, from the plurality of teams, the user inputs via the one or more roll-up shapes. The method further includes aggregating the user inputs to generate insights related to the plurality of teams of the organization.

### CROSS-REFERENCE TO RELATED APPLICATIONS

This application claims the benefit of U.S. patent application Ser. No. 63/782,323, , filed on Apr. 2, 2025; the disclosure of which is incorporated herein by reference in its entirety.

### FIELD

The embodiments discussed herein are related to team management and data roll up.

### BACKGROUND

Unless otherwise indicated herein, the materials described herein are not prior art to the claims in the present application and are not admitted as prior art by inclusion in this section.

Diagrams or other visualizations may help collaboration between multiple users. For example, multiple members of a team may collaboratively contribute data to a shared digital whiteboard. The team members may also provide feedback on the collaboration process via the visual activities.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a computer-implemented method to roll up data from a canvas includes providing a blueprint to a plurality of teams of an organization. The blueprint includes one or more roll-up shapes soliciting user inputs. The method may include receiving, from the plurality of teams, the user inputs via the one or more roll-up shapes. The method further includes aggregating the user inputs to generate insights related to the plurality of teams of the organization.

In another example embodiment, a non-transitory computer-readable medium has computer-readable instructions stored thereon that are executable by a processor to perform or control performance of operations. The operations include providing a blueprint to a plurality of teams of an organization. The blueprint may include one or more roll-up shapes soliciting user inputs. The operations may include receiving, from the plurality of teams, the user inputs via the one or more roll-up shapes. The operations may further include aggregating the user inputs to generate insights related to the plurality of teams of the organization.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example operating environment that includes a server and one or more client devices;

FIGS. 2A-2E include graphical representations of a user interface (UI) to generate graphical diagrams;

FIGS. 3A-3B include graphical representations of another UI to generate graphical diagrams;

FIG. 4 illustrates a flowchart of an example method to display graphical diagrams that may be implemented in the operating environment of FIG. 1 and/or the UIs of FIGS. 2A-2E; and

FIG. 5 is a block diagram illustrating an example computing device that is arranged to generate and/or display graphical diagrams, all arranged in accordance with at least one embodiment described herein.

### DETAILED DESCRIPTION OF SOME EXAMPLE EMBODIMENTS

Some organizations may have multiple teams and/or sub-organizations within the organizations. The teams may work on independent projects and/or collaborative projects between the teams. The teams may implement the projects using elements on a canvas. A canvas may refer to a collaborative workspace in which one or more users may provide inputs. As the teams are working on various projects, managerial oversight over different teams and/or projects may become difficult. For example, organizational managers may have difficulty assessing confidences that the teams and/or team members have on different projects. Obtaining the information repeatedly increases the difficulty of the assessment process. Such information may provide valuable insights into progress of the projects and teams, such that different managerial actions may be taken.

Some existing approaches to managerial insights may include structured surveys. For instance, survey forms including specific questions may be sent out to team members to complete. The survey forms may be used to collect feedback, opinions, and insights from individuals and/or teams. For example, a survey asking how confident the individuals are on certain projects or project sprints may be distributed and collected. However, such survey forms may require the survey takers to step away from the projects to complete, which may decrease participation. Additionally, analyzing the survey results across a large organization may be difficult. For instance, the gathered data may be entered into a document (e.g., a spreadsheet) in which further analyses must be taken.

Another approach to managerial insights may include thorough inspection of the content of a system of record. For example, to gain insights into project progress, number of committed code lines and/or point totals in sprints may be inspected. The inspection may indirectly provide the progress and/or confidence that the team members have on the project. For instance, more committed code lines may represent the progress being made. However, the value or progress associated with the committed code lines may vary based on the project. For example, the same number of committed code lines may represent significant progress for a particular project and represent only a small progress for another project. Further, such an approach may increase required manual labor and cost. For instance, an operator may be required to manually inspect the content of the system of record for different teams and/or projects to determine the progress and/or confidence of the teams and members.

Finally, another existing approach may include providing a large amount of internal documents to artificial intelligence (AI) models such as large language models (LLMs). The AI models may be configured to process the internal data to try to identify useful insights into the projects, teams, and members of the teams. However, such an approach may not provide clear insights as the insights may be clouded with the large amount of information provided to the AI models.

Some embodiments herein may permit management of an organization to gather insights into different teams, members, and/or projects via roll-ups. Particularly, the embodiments herein may permit the management to gather the insights without requiring the teams and/or the members to step away from daily work or projects. For example, in some embodiments, the teams may utilize blueprints to initiate or manage projects. The blueprints may include a set of standardized templates that may be configured by an admin and distributed to teams. For example, the blueprints may include templates that the teams may use in running the projects. In some embodiments, the admin may provide different blueprints for different types of projects. For example, a particular blueprint may be suitable for team sprints where a team works to complete a set amount of work, typically defined as a set of tasks, user stories, or features. Additionally or alternatively, the blueprints may include a set of additional inputs. For example, the blueprints may include data from other documents. For example, the blueprints may include outputs from other templates, blueprints, documents, etc. The blueprints may obtain any other suitable types of third-party data. In some embodiments, the relevant data from such documents may be identified and injected into the templates and/or blueprints as the templates and/or the blueprints are instantiated by the users. In these and other embodiments, injecting the data may refer to inserting the data into relevant parts of the templates. For example, a document may include description of the team, including team members and roles of a particular team. Such information may be injected such that the blueprint is customized for the particular team.

In some embodiments, the blueprints may include one or more roll-up shapes. The roll-up shapes may refer to shapes and/or elements within the blueprints that may have data added. For example, users may provide roll-up data or feedback via the roll-up shapes. In some embodiments, the roll-up data added to the roll-up shapes may be aggregated. The aggregated data may provide insights of the feedback from the individuals for admin review. The roll-up shapes may permit the management to gather feedback from the teams and individuals without taking the teams and the individuals away from the projects. In some embodiments, additional information present within the canvas or the workspace may be aggregated along with or in addition to the data present in the roll-up shapes.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

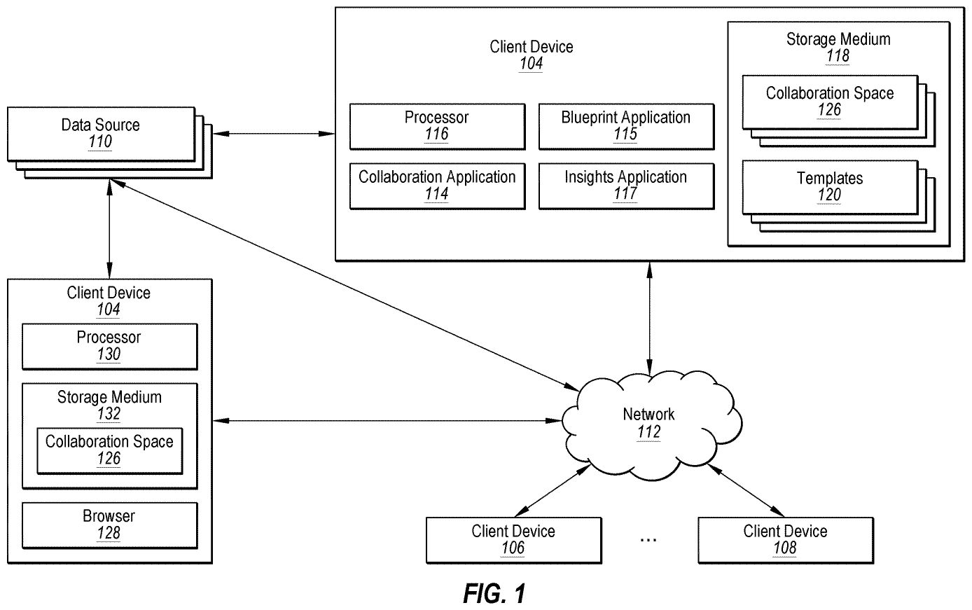

FIG. 1 is a block diagram of an example operating environment 100 for an insight platform 101, arranged in accordance with at least one embodiment described herein. The environment 100 includes a server 102, one or more client devices 104, 106, 18 and a network 112.

In general, the network 112 may include one or more wide area networks (WANs) and/or local area networks (LANs) that enable the server 102, the client devices 104, 106, 108 to communicate with each other. In some embodiments, the network 112 may include the Internet, including a global internetwork formed by logical and physical connections between multiple WANs and/or LANs. Alternately or additionally, the network 112 may include one or more cellular radio frequency (RF) networks and/or one or more wired and/or wireless networks such as 802.xx networks, Bluetooth access points, wireless access points, Internet Protocol (IP)-based networks, or other wired and/or wireless networks. The network 112 may also include servers that enable one type of network to interface with another type of network.

In some embodiments, the server 102 may be managed or operated by an organization. In these and other embodiments, the client devices 104, 106, 108 may be or include devices used by members of the organization. For example, the client devices 104, 106, 108 may be used by employees of the organization. In some embodiments, the server 102 and/or the client devices 104, 106, 108 may be configured to permit members or users, e.g., users of the client devices 104, 106, 108, to communicate and collaborate online in real time. For example, the server 102 may generally host collaboration spaces 126, each of which may be accessed by one or multiple users simultaneously or asynchronously via client devices 104, 106, 108. Within the collaboration spaces 126, users may generate graphical diagrams or visualizations with graphical objects or content authored by users via a collaboration application 114 hosted by the server 102.

In some embodiments, the collaboration space 126 may be generated based on blueprints generated by blueprint application 115. In some embodiments, the blueprints may include a set of standardized templates 120 that may be pre-configured and distributed to the client devices 104, 106, 108. In some embodiments, the templates 120 may be configured by an admin or management of an organization. In some embodiments, the templates 120 may be configured by other parties, such as end users or teams, or other third parties. In some embodiments, the templates may be configured by multiple parties. For example, a template initially configured by the admin may be revised by a user. The templates 120 may include different structures or graphic diagrams that may guide users through different projects. For instance, the admin of the organization associated with the insight platform 101 and the server 102 may generate the blueprints via the blueprint application 115. The blueprints may include templates 120 that may vary based on type of projects being run. For example, a blueprint for a project sprint may be generated based on one or more templates 120 associated with the sprint. In some embodiments, the templates 120 and the contents of the templates 120 may be adjusted or modified to fit specifications of different projects. For example, a blueprint for a sprint may include templates 120 or visualizations related to sprint planning, daily standup, decision tree, etc. In some embodiments, the blueprints may be adjusted and/or customized based on user preferences.

In some embodiments, the blueprints may be generated based on input documents. The input documents may include information that may be used to customize and/or adjust the blueprints. For example, a document may include team data, such as team member profiles, roles of the team, projects associated with the team, etc. In these and other embodiments, the information included in the document may be used to update and adjust the templates 120 and/or the blueprint to be more relevant or suitable for the team.

In some embodiments, the blueprints may be defined such that the blueprints include one or more roll-up shapes. The roll-up shapes may refer to elements within the blueprints that may have different types of data added to it. The roll-up shapes may be configured to obtain inputs from the users via the client devices 104, 106, 108 and to communicate the inputs to the server 102. In some embodiments, the roll-up shapes may be configured to initiate users to provide certain information that may be useful for further analysis. For example, the roll-up shapes may be used to gather information that may be used by the management and/or the admin in gathering insights on the projects and the teams. For example, in a blueprint associated with a project sprint, a roll-up shape may initiate users of the client devices 104, 106, 108, to provide confidence levels in the sprint plan or the sprint process. In these and other embodiments, the roll-up shapes may be integrated with the blueprints such that the users may provide such feedback as part of the blueprint without diverting away from the projects.

In some embodiments, the roll-up shapes may solicit user inputs (e.g., feedback) or data via visual activities. For example, a roll-up shape may include a 1-axis visual activity in which the user provides movement or attention within an axis of movement. For example, a roll-up shape may include a line representing confidence levels and a selector which may be moved across the line to select a particular confidence level. In some embodiments, roll-up shapes may include 2-axis visual activities that involve movements in both the horizontal and vertical directions. Additionally or alternatively, the roll-up shapes may be configured to solicit numerical inputs or data. In some embodiments, the roll-up shapes may be configured to solicit text inputs. For example, with respect to confidence levels, the text inputs may include context explaining the confidence levels. In some embodiments, the server 102 or the insights application 117 may include an artificial intelligence (AI) model, such as a large language model (LLM) configured to analyze the text inputs. For example, the insights application 117 may be configured to utilize the AI model to aggregate and/or summary the text inputs. In some embodiments, other types of data may also be rolled up. For example, the types of data may include graphic data (e.g., image data, video data). For example, a set of images (e.g., emojis) may be provided as input data by user(s). The data (e.g., metadata associated with the set of images) may be rolled up to be aggregated. As another example, the number of JIRA cards within the workspace or within a frame of the workspace. While described with certain examples, the data from any or all parts of the canvas workspace may be rolled up.

As used herein, the term “visual activity” may include a digital activity as described in U.S. App. No. Ser. No. 17/932,237, filed on Sep. 14, 2022, and entitled CREATION AND DEPLOYMENT OF DIGITAL ACTIVITY, which is incorporated herein by reference for all purposes. In general, such a visual activity or digital activity may include one or more interactive design elements that may be displayed in a collaboration space to solicit and obtain user input in some form.

In some embodiments, the information gathered from the client devices 104, 106, 108 may be communicated to the server 102 and analyzed by an insight application 117. The insight application 117 may be configured to roll up the information from the collaboration space 126 to generate insights. In these and other embodiments, a reference to rolling up the information may be or include a reference to aggregating and analyzing the information to generate insights that provide an overview of the information. For example, in some embodiments, the data provided from the client devices 104, 106, 108 via the roll-up shapes may be rolled up or aggregated. For example, the confidence levels of different individuals or teams may be aggregated such that the insights may indicate the confidence levels of different teams of the organization. In these and other embodiments, the rollups may allow the management and/or the admin to gain insights into the projects and/or visualizations without directly assessing the visualizations. For instance, without the rollups, the user inputs and contents are tied to the collaboration space and/or the visualization, in which the admin may be required to directly access the visualizations to access the information.

In some embodiments, the insights application 117 may be configured to roll up or aggregate additional information that is present in the collaboration space 126 or the visualizations in the collaboration space 126 other than the roll-up shapes. For instance, the insights application 117 may be configured to roll up additional text content added to the collaboration space 126. For example, a comment or feedback may be provided as text content on a sticky note. In some embodiments, the insights application 117 may be configured to roll up such text content to generate the insights.

In some embodiments, the insights application 117 may be configured to filter the information obtained from the collaboration space 126. For example, the insights application 117 may filter the user inputs to identify information that may be useful for the management of the organization. In some embodiments, the user inputs may be filtered prior to being aggregated such that only the useful information may be aggregated. In these and other embodiments, the useful information may refer to information that provides insights to how the teams are performing rather than the substance of the projects.

In some embodiments, the insights application 117 may be configured to roll up the information on any of a variety of bases, such as per roll-up shape, across multiple roll-up shapes, per team, across multiple teams, or the like. For example, a blueprint may include a first roll-up shape and a second roll-up shape. In these and other embodiments, the insights application 117 may roll up data from all first roll-up shapes across different teams together and roll up data from all second roll-up shapes across different teams together.

In some embodiments, the rollups may be done at different levels. For example, the insights application 117 may roll up data at team level (e.g., aggregate data from the individuals for each team) and aggregate at a blueprint level (e.g., aggregate all data for the blueprint across multiple teams). In these and other embodiments, the varying levels of rollups may provide detailed views into the rolled-up data. In these and other embodiments, the insights may be organized and/or presented in a manner corresponding to the different levels of rollups. For example, the insights may be organized based on blueprints

In some embodiments, the insights application 117 may be configured to roll up in a manner to keep track of changes. For example, the confidence levels of the teams may change as multiple iterations of sprints are run. The insights application 117 may keep track of the changes in the rolled-up data (e.g., the confidence levels).

The server 102 may additionally include a processor 116 and a storage medium 118. The processor 116 may be of any type such as a central processing unit (CPU), a microprocessor (μP), a microcontroller (μC), a digital signal processor (DSP), or any combination thereof. The processor 116 may be configured to execute computer instructions that, when executed, cause the processor 116 to perform or control performance of one or more of the operations described herein with respect to the server 102. Such computer instructions may be embodied in the collaboration application 114, the blueprint application 115, the insights application 117, other applications or software, or the like.

The storage medium 118 may include any non-transitory computer-readable medium, including volatile memory such as random access memory (RAM), persistent or non-volatile storage such as read only memory (ROM), electrically erasable and programmable ROM (EEPROM), compact disc-ROM (CD-ROM) or other optical disk storage, magnetic disk storage or other magnetic storage device, NAND flash memory or other solid state storage device, or other persistent or non-volatile computer storage medium. The storage medium 118 may store computer instructions that may be executed by the processor 116 to perform or control performance of one or more of the operations described herein with respect to the server 102. For example, one or more of the collaboration application 114, the blueprint application 115, the insights application 117, other applications or software, or the like, may be stored in the storage medium 118 and/or may be loaded into memory for execution by the processor 116.

Although one server 102 and three client devices 104, 106, 108 are illustrated in FIG. 1, the operating environment 100 may more generally include one or more servers 102 and one or more client devices 104, 106, 108. In these and other embodiments, the operating environment 100 may include other servers and/or devices not illustrated in FIG. 1.

Each of the client devices 104, 106, 108 may execute an application, such as the browser 128, configured to communicate through the network 112 with the server 102. The browser 128 may include an Internet browser or other suitable application for communicating through the network 112 with the server 102. Each of the client devices 104, 106, 108 may include a desktop computer, a laptop computer, a tablet computer, a mobile phone, a smartphone, a personal digital assistant (PDA), a wearable device (e.g., a smart watch), or another suitable client device.

Each of the client devices 104, 106, 108 may additionally include a processor and a storage medium, such as a processor 130 and a storage medium 132 as illustrated for the client device 104 in FIG. 1. Each of the other client devices 106, 108 may be similarly configured. Similar to the processor 116 of the server 102, the processor 130 may be of any type such as a CPU, a μP, a μC, a DSP, or any combination thereof. The processor 130 may be configured to execute computer instructions that, when executed, cause the processor 130 to perform or control performance of one or more of the operations described herein with respect to the client device 104 and/or the browser 128.

Similar to the storage medium 118 of the server 102, the storage medium 132 of the client device 104 may include any non-transitory computer-readable medium, including volatile memory such as RAM, persistent or non-volatile storage such as ROM, EEPROM, CD-ROM or other optical disk storage, magnetic disk storage or other magnetic storage device, NAND flash memory or other solid state storage device, or other persistent or non-volatile computer storage medium. The storage medium 132 may store computer instructions that may be executed by the processor 130 to perform one or more of the operations described herein with respect to the client device 104 and/or the browser 128. The storage medium 132 may additionally store, at least temporarily, a graphical diagram 126 and/or other content obtained from the server 102 and/or generated locally on the client device 104.

Embodiments described herein are not limited to using a browser to communicate with the server 102 to generate and display graphical diagrams 126 based on textual inputs. For example, rather than or in addition to a browser, the client devices 104, 106, 108 may include a native app as are often used on client devices such as mobile devices including smartphones and tablet computers. Accordingly, embodiments described herein generally include generating and displaying graphical diagrams using a browser, a native app, or another suitable application on the client devices 104, 106, 108.

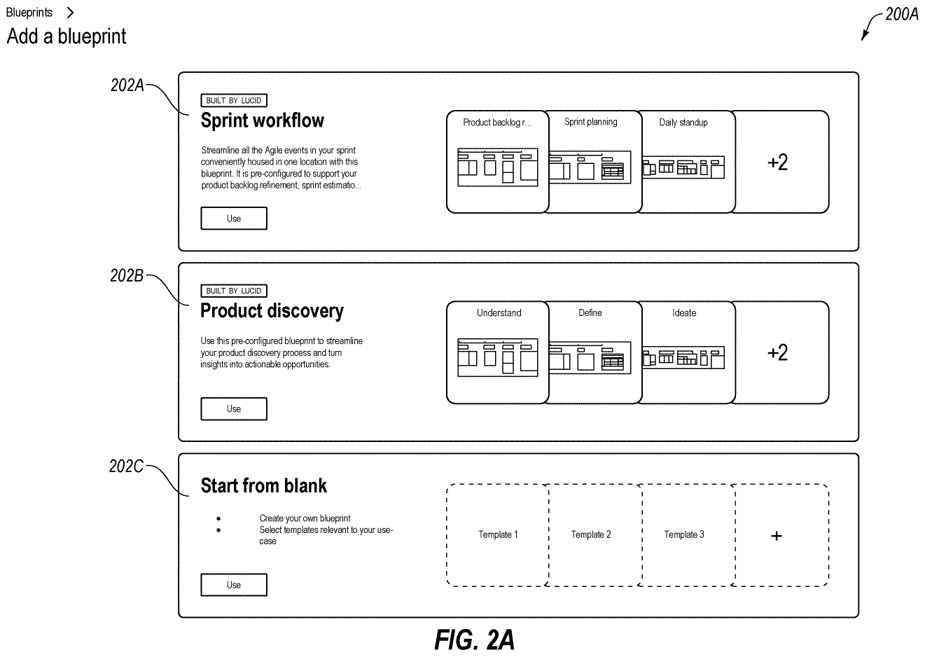

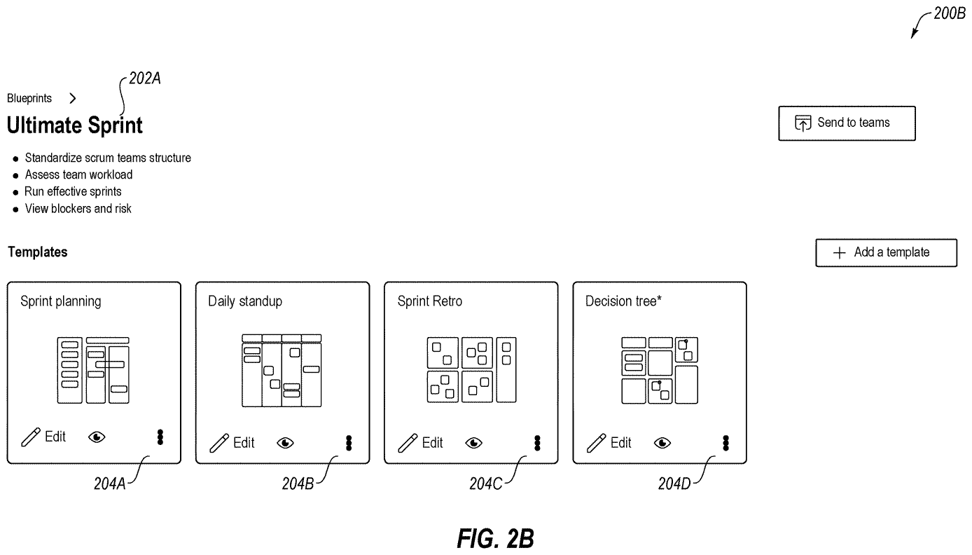

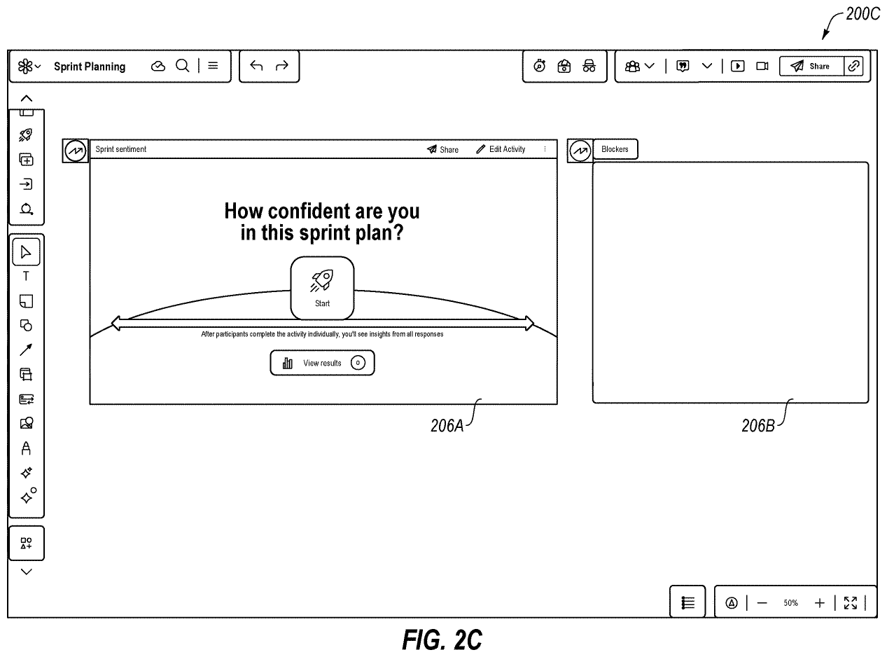

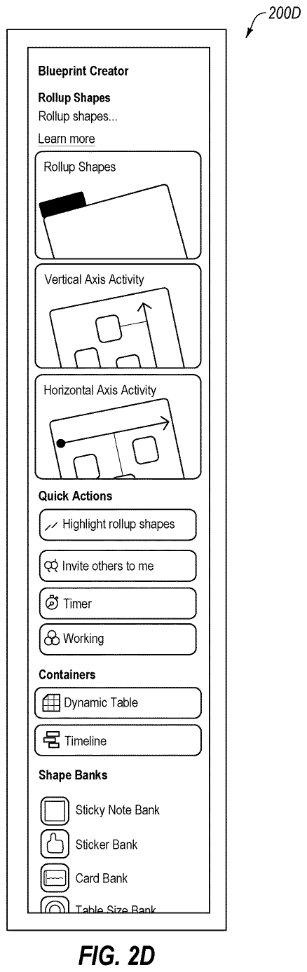

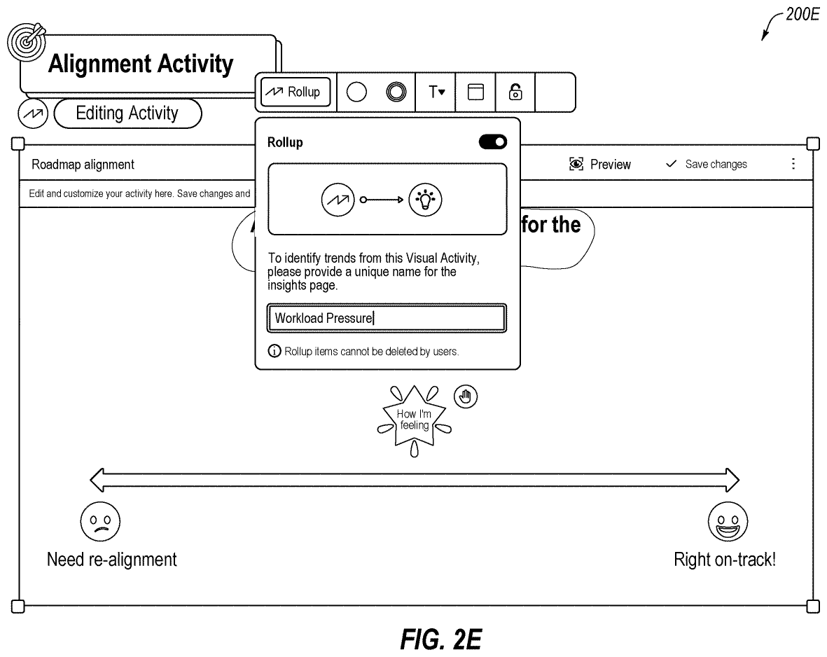

FIGS. 2A-2E include graphical representations 200A, 200B, 200C, 200D, and 200E (collectively “graphical representations 200”) of a UI to generate and/or define blueprints, arranged in accordance with at least one embodiment described herein. The UI may be provided by the blueprint application 115 of FIG. 1. In some embodiments, the UI may be provided to an admin or a management of an organization.

With reference to FIG. 2A, the graphical representation 200A illustrates an initial page or interface to generate a blueprint. The graphical representation 200A illustrates one or more options that may be selected for the blueprint. For example, the graphical representation 200A illustrates a first option 202A, a second option 202B, and a third option 200C (collectively referred to as “options 202”). In some embodiments, the options 202 may be structured to include different templates that may be suitable for different tasks or projects. In some embodiments, the options 202 may be predefined. For example, the options 202 may be selected and saved, such that the options 202 may be loaded in the future. In some embodiments, the options 202 may include a blank option (e.g., the third option 202C). The blank option may not include any preselected templates to permit the blueprint to be built from scratch.

With reference to FIG. 2B, in response to selecting an option (e.g., the first option 202A) from the available options 202 in FIG. 2A, one or more templates may be displayed as illustrated in the graphical representation 200B of FIG. 2B. As illustrated in FIG. 2B, the set of templates may include a first template 204A, a second template 204B, a third template 204C, and a fourth template 204D (collectively referred to as “templates 204”). In some embodiments, the templates 204 may include different structures or graphic diagrams that may guide users through different projects. For example, the templates 204 may include different visualizations that may be used in the projects. For example, in instances in which the first option 202A is related to a sprint, the first template 204A may include a sprint planning template, the second template 204B may include a daily standup template, the third template 204C may include a sprint retro template, and the fourth template 204D may include a decision tree template. In some embodiments, each option (e.g., of the options 202 of FIG. 2A) may be associated with any suitable number and/or combination of templates (e.g., templates 204 of FIG. 2B), selected based on teams, preferences, projects, etc.

In some embodiments, contents of the templates 204 may be revised and/or adjusted, as illustrated in and described with respect to the graphical representation 200C of FIG. 2C. The graphical representation 200C illustrates a UI in which different contents of the templates 204 may be adjusted. In response to selecting one of the templates 204 as illustrated in FIG. 2B, contents and/or elements of the selected template are populated on the UI. For example, the graphical representation 200C illustrates a first element 206A and a second element 206B which may be part of a particular template. The first element 206A and the second element 206B may include different activities that are part of the template 204. In some embodiments, the layout of the elements may be adjusted or edited. For example, the first element 206A and the second element 206B may be moved to different locations within the particular template. The adjustments may allow the admin to adjust the blueprint to solicit information needed for the admin. For example, as illustrated with the first element 206A, the templates may be adjusted to include an element soliciting team members to provide information regarding confidence levels in the sprint or sprint plans.

In some embodiments, the additional contents or elements may be added to the templates. For example, roll-up shapes and/or additional activities may be added to the templates. FIG. 2D illustrates the graphical representation 200D for a UI for adding one or more roll-up shapes. The UI is used to select different types of roll-up shapes to be added to the templates. Different types of roll-up shapes may be used to solicit different responses. For example, roll-up shapes may be configured to solicit text data, numerical data, etc. In some embodiments, the type of roll-up shapes may include visual activities that may be used to solicit information. For example, FIG. 2E illustrates an example single-axis visual activity in the graphical representation 200E being configured by the admin for inclusion in the blueprint.

In some embodiments, appearances of the adjustments and/or the roll-ups may be customized and/or defined. For example, shapes and locations of the roll-up shapes may be defined. Additionally or alternatively, the characteristics of the roll-up shapes may be defined. For example, the characteristics may include type of activity (e.g., vertical axis activity, horizontal axis activity), type of inputs (e.g., numerical inputs, text inputs, etc.) represented by the roll-up shapes, and/or other characteristics.

In some embodiments, the roll-up shapes may be defined such that the roll-up shapes may be used in a same document or blueprint on a recurring basis. For example, the same document may be used by multiple users and/or multiple times by a same user. Additionally or alternatively, in some embodiments, the roll-up shapes may be used in multiple documents that are used at different instances (e.g., sprint events that occur at different stages). In these and other embodiments, the insights may be collected continuously over multiple instances. For example, information within the roll-up shapes may be continuously monitored, and the insights may be configured to reflect the changes over different instances. As an example, the data contained in a particular roll-up shape (e.g., a roll-up shape associated with team sentiment) may be snapshot each time the document is used. The changes in the data contained in the particular roll-up shape may provide how the team sentiment changed over time. Such an approach may allow the admin to view the changes along with the most current information.

In some embodiments, the blueprints may be provided to one or more teams within the organization. In some embodiments, the blueprints may be provided to all teams within the organization. In other embodiments, admins may send the blueprints to specific teams within the organization. While discussed with respect to project sprints, the blueprints may be generated for any other types of projects or works performed by different teams of an organization.

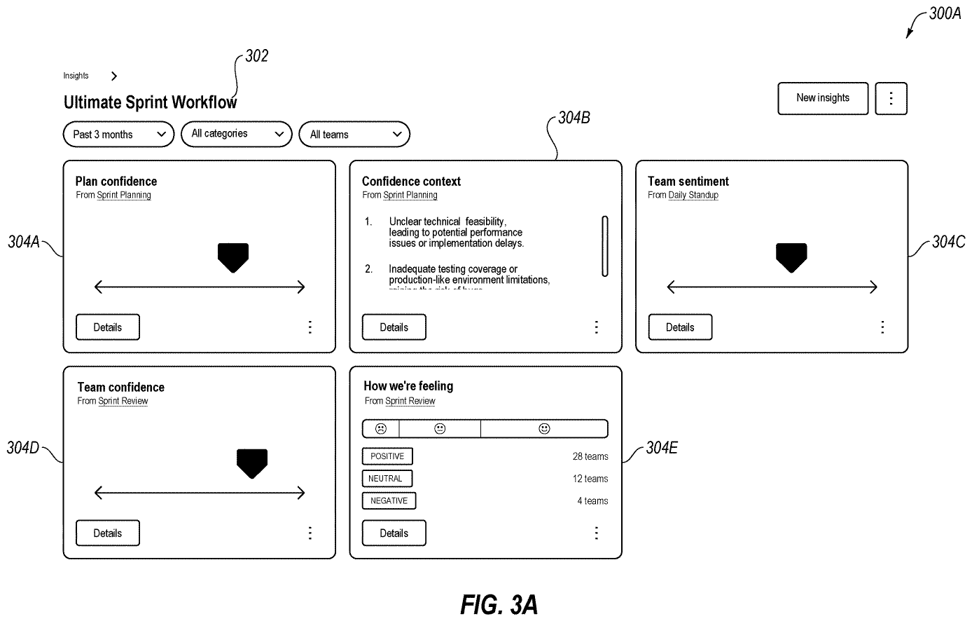

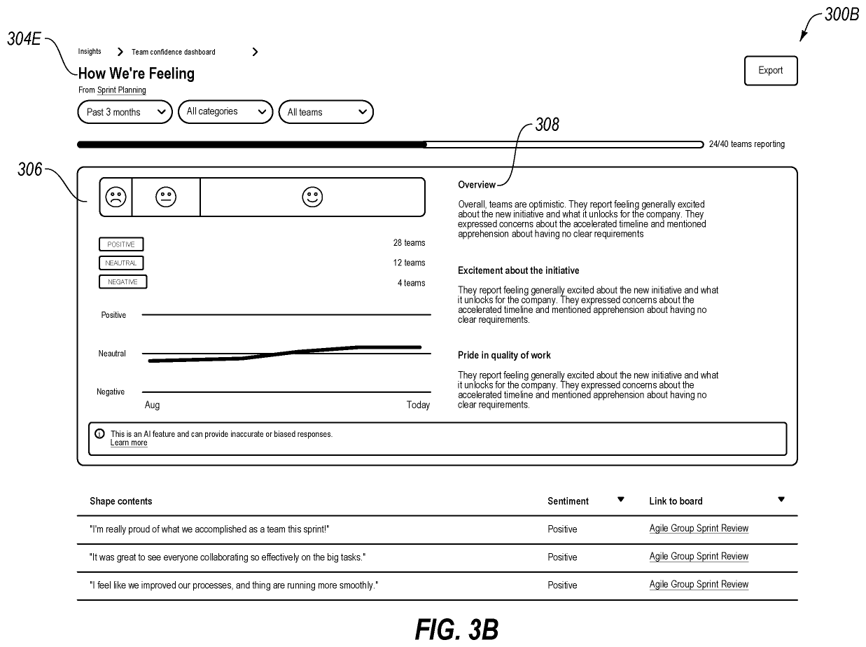

FIGS. 3A-3B include graphical representations 300A, 300B (collectively “graphical representations 300”) of example insight dashboards, arranged in accordance with at least one embodiment described herein. The insight dashboards may be configured to present the insights or data obtained via the blueprints in a certain format. For example, the insights may aggregate or roll up the data provided by users or teams via the blueprints, such that the management and/or the admin may gain insights to different teams and/or projects.

In some embodiments, the insight dashboards may present insights on a blueprint basis. For example, the graphical representation 300A of FIG. 3A illustrates insights for a first blueprint 302. For example, the graphical representation 300A may illustrate a first insight 304A, a second insight 304B, a third insight 304C, a fourth insight 304D, and a fifth insight 304E (collectively referred to as “insights 304”). In some embodiments, each insight 304 may represent different roll-up shapes. For example, the first insight 304A may represent data aggregated from a roll-up shape associated with plan confidence (e.g., confidence level in the sprint plan). The second insight 304B may represent data aggregated from text inputs associated with the confidence levels. The third insight 304C may represent data aggregated from a roll-up shape associated with team sentiment on the sprint and/or the project. The fourth insight 304D may represent data aggregated from a roll-up shape associated with team confidence. In some embodiments, the fifth insight 304E may represent data aggregated from a roll-up shape associated with sprint review.

In some embodiments, individual insights may be selected for additional details. For example, the graphical representation 300B of FIG. 3B illustrates details of the fifth insight 304E and/or may be displayed in response to selection of the fifth insight 304E in FIG. 3A. In some embodiments, the details may include graphical view 306 of the aggregated data and/or textual view 308 of the aggregated data. The details of the fifth insight 304E (e.g., sprint review) may provide an overview of how the teams are feeling about the respective sprints. In some embodiments, the graphical view 306 may illustrate the change in the confidence levels over time. The textual view 308 may provide a textual summary and/or overview of responses or feedback from the teams.

In some embodiments, the insights 304 may provide suggested actions based on the insights 304. For example, certain insights may indicate common issues or problems among the teams. In such instances, the related insights may provide suggested actions for the admin to improve the common issues. For example, the insights 304 may indicate low confidence levels with respect to the sprint plans (e.g., the first insight 304A). In this or other examples, the insights 304 may include actions recommended to improve the confidence levels in the sprint plans. In some embodiments, the recommended actions may vary for different teams. For example, a particular team may show particularly low confidence level compared to other teams. In such an instance, a particular recommended action may be provided for the particular team. While discussed with respect to project sprints, the insights 304 may be provided for any other types of projects or works performed by different teams of an organization.

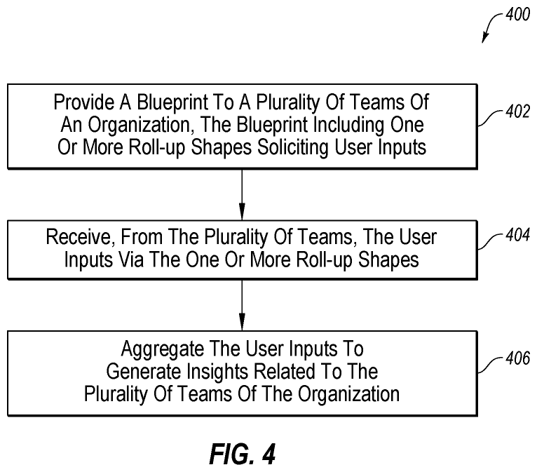

FIG. 4 illustrates a flowchart of an example method 400 to generate graphical diagrams, arranged in accordance with at least one embodiment described herein. The method 400 may be performed by any suitable system, apparatus, or device. For example, any one or more of the client devices 104, 106, 108, the blueprint application 115, the collaboration application 114, the insights application 117 and/or the server 102 of FIG. 1 may perform or direct performance of one or more of the operations associated with the method 400. In these and other embodiments, the method 400 may be performed or controlled by one or more processors based on one or more computer-readable instructions stored on one or more non-transitory computer-readable media. Alternatively or additionally, embodiments herein may include a non-transitory computer-readable medium having computer-readable instructions stored thereon that are executable by a processor to perform or control performance of the method 400 or one or more operations thereof. The method 400 may include one or more of blocks 402, 404, and/or 406.

At block 402, the method 400 may include providing a blueprint to multiple teams of an organization. In some embodiments, the blueprint may include one or more roll-up shapes soliciting user inputs. In some embodiments, the one or more roll-up shapes may include input fields configured to have data added. For example, the roll-up shapes may be configured to obtain input data from the users. The input data may be communicated to the server and/or insights platform associated with the organization.

In some embodiments, the one or more roll-up shapes may be configured to obtain different types of input data. For example, in some embodiments, the roll-up shapes may be configured to obtain text data and/or numerical data. The text data and numerical data may be aggregated using any suitable approaches or methods. For example, the text data may be aggregated using an AI model configured to summarize the text data. The numerical data may be aggregated using any methods suitable for statistically useful aggregation of the values. For example, an average value of the numerical data may be determined. In some embodiments, the roll-up shapes may include visual activities, in which the actions taken with respect to the visual activities are taken as the user inputs. In some embodiments, a particular blueprint may include any suitable number of roll-up shapes. In these and other embodiments, the particular blueprint may include different combinations of types of roll-up shapes (e.g., different roll-up shapes configured to receive different types of input data).

In some embodiments, prior to providing the blueprint to the multiple teams of the organization, the blueprint may be generated. In some embodiments, generating the blueprint may include selecting a predefined blueprint including one or more templates from a set of predefined blueprints. The set of predefined blueprints may be blueprints previously generated by the management of the organization and/or blueprints recommended by the system. In some embodiments, the blueprints may be custom generated from scratch. For example, the operator (e.g., an admin) generating the blueprint may select one or more templates suitable for the blueprint. In some embodiments, the one or more templates may be edited to include the one or more roll-up shapes. Block 402 may be followed by block 404.

At block 404, the method 400 may include receiving, from the multiple teams of the organization, the user inputs via the one or more roll-up shapes. For example, the user inputs provided by the teams or members of the teams of the organization may be stored in a server (e.g., the server 102 of FIG. 1) and/or an insight application (e.g., the insights application 117 of FIG. 1). In some embodiments, the user inputs may be obtained at different times. In some embodiments, the user inputs obtained within a certain timeframe may be grouped together for further analysis. Block 404 may be followed by block 406.

At block 406, the method 400 may include aggregating the user inputs to generate insights related to the plurality of teams of the organization. In some embodiments, the insights may provide information regarding the status of the multiple teams of the organization. The insights may provide answers to the questions associated with the roll-up shapes. In these and other embodiments, the insights may aggregate the user inputs together such that the admin of the organization may view the summary of the user inputs. In some embodiments, the user inputs may be first aggregated at a team level, in which the insights are generated for each team of the multiple teams. Additionally or alternatively, the user inputs may be aggregated at blueprint level, in which all user inputs within the blueprint are aggregated together. Aggregating inputs in this manner may provide the admin with a global overview (within the business or entity) without the admin having to review each team's feedback individually.

In some embodiments, the method 400 may further include, prior to aggregating the user inputs, filtering the user inputs to identify information useful for the management of the organization. For example, the management may apply one or more filters to identify specific and substantive details of the projects that the teams are working on. In these and other embodiments, the insights may include information regarding teams rather than specific details of the projects the teams are working on.

In some embodiments, the method 400 may include determining one or more suggested actions based on the insights. For example, the insights may indicate a possibility of an issue with a particular team. In such instances, one or more actions that may help improve the issue may be determined. In some embodiments, the one or more suggested actions may be applicable to the multiple teams of the organization in general. In some embodiments, a notification may be sent to the management or the admin of the organization, such that appropriate actions may be taken to address the issues.

In some embodiments, the method 400 may further include receiving updated user inputs from the teams via the one or more roll-up shapes. For example, in some embodiments, the teams may use a template or a blueprint multiple time. In each use, rather than creating a fresh document from the blueprint each instance, the teams may continue using the same document and update the responses. In some embodiments, the updated user inputs may be aggregated to generate updated insights. In some embodiments, the updated insights may be recorded and/or stored without replacing the insights. For example, the insights and the updated insights may both be kept. In some embodiments, the insights and the updated insights may be compared to identify the difference between the insights and the updated insights. In these and other embodiments, the differences may provide admins and/or users the ability to track and/or monitor how the response change over time.

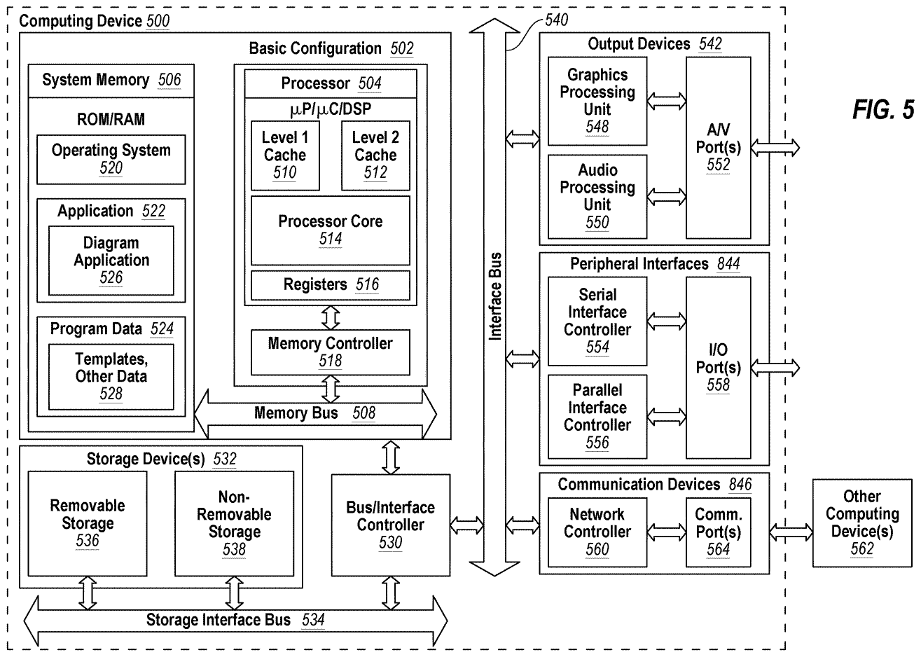

FIG. 5 is a block diagram illustrating an example computing device 500 that is arranged to generate and/or display graphical diagrams, arranged in accordance with at least one embodiment described herein. The computing device 500 may include, be included in, or otherwise correspond to either or both of the server 102 or the client devices 104, 106, 108 of FIG. 1. In a basic configuration 502, the computing device 500 typically includes one or more processors 5504 and a system memory 506. A memory bus 508 may be used to communicate between the processor 5504 and the system memory 506.

Depending on the desired configuration, the processor 5504 may be of any type including, but not limited to, a microprocessor (μP), a microcontroller (μC), a digital signal processor (DSP), or any combination thereof. The processor 5504 may include one or more levels of caching, such as a level one cache 510 and a level two cache 512, a processor core 514, and registers 516. The processor core 514 may include an arithmetic logic unit (ALU), a floating point unit (FPU), a digital signal processing core (DSP Core), or any combination thereof. An example memory controller 518 may also be used with the processor 5504, or in some implementations the memory controller 518 may include an internal part of the processor 5504.

Depending on the desired configuration, the system memory 506 may be of any type including volatile memory (such as RAM), nonvolatile memory (such as ROM, flash memory, etc.), or any combination thereof. The system memory 506 may include an operating system 520, one or more applications 522, and program data 5524. The application 522 may include a diagram application 526 that is arranged to generate and/or display graphical diagrams. The diagram application 526 may include, be included in, or otherwise correspond to one or more of the collaboration application 114, the blueprint application 115, and/or the insights application 117 of FIG. 1. The program data 524 may include templates and/or other data 528 (which may include, be included in, or otherwise correspond to templates 120, collaboration spaces 126 of FIG. 1 and/or roll-up date (e.g., aggregated user inputs)) and/or other data. In some embodiments, the application 522 may be arranged to operate with the program data 524 on the operating system 520 such that one or more methods may be provided as described herein.

The computing device 500 may have additional features or functionality, and additional interfaces to facilitate communications between the basic configuration 502 and any involved devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

The system memory 506, the removable storage devices 536, and the non-removable storage devices 538 are examples of computer storage media or non-transitory computer-readable media. Computer storage media or non-transitory computer-readable media includes RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other non-transitory medium which may be used to store the desired information, and which may be accessed by the computing device 500. Any such computer storage media or non-transitory computer-readable media may be part of the computing device 500.

The computing device 500 may also include an interface bus 540 to facilitate communication from various interface devices (e.g., output devices 542, peripheral interfaces 5544, and communication devices 546) to the basic configuration 502 via the bus/interface controller 530. The output devices 542 include a graphics processing unit 548 and an audio processing unit 550, which may be configured to communicate to various external devices such as a display or speakers via one or more A/V ports 552. Diagrams, flowcharts, organizational charts, connectors, and/or other graphical objects generated by the diagram application 526 may be output through the graphics processing unit 548 to such a display. The peripheral interfaces 544 include a serial interface controller 554 or a parallel interface controller 556, which may be configured to communicate with external devices such as input devices (e.g., keyboard, mouse, pen, voice input device, touch input device, etc.), sensors, or other peripheral devices (e.g., printer, scanner, etc.) via one or more I/O ports 558. Such input devices may be operated by a user to provide input to the diagram application 526, which input may be effective to, e.g., generate curved connectors, designate points as designated points of one or more curved connectors, relocate one or more designated points, and/or to accomplish other operations within the diagram application 526. The communication devices 546 include a network controller 560, which may be arranged to facilitate communications with one or more other computing devices 562 over a network communication link via one or more communication ports 564.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media” as used herein may include both storage media and communication media.

The computing device 500 may be implemented as a portion of a small-form factor portable (or mobile) electronic device such as a smartphone, a personal data assistant (PDA) or an application-specific device. The computing device 500 may also be implemented as a personal computer including tablet computer, laptop computer, and/or non-laptop computer configurations, or a server computer including both rack-mounted server computer and blade server computer configurations.

Embodiments described herein may be implemented using computer-readable media for carrying or having computer-executable instructions or data structures stored thereon. Such computer-readable media may be any available media that may be accessed by a general-purpose or special-purpose computer. By way of example, such computer-readable media may include non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method to roll up data from a canvas, the method comprising:
providing a blueprint to a plurality of teams of an organization, the blueprint including one or more roll-up shapes soliciting user inputs;
receiving, from the plurality of teams, the user inputs via the one or more roll-up shapes; and
aggregating the user inputs to generate insights related to the plurality of teams of the organization.

2. The computer-implemented method of claim 1, further comprising, prior to providing the blueprint to the plurality of teams of the organization, generating the blueprint.

3. The computer-implemented method of claim 2, wherein generating the blueprint comprises:
selecting one or more templates suitable for the blueprint; and
editing the one or more templates to include the one or more roll-up shapes.

4. The computer-implemented method of claim 3, wherein the one or more templates include corresponding visual activities.

5. The computer-implemented method of claim 2, wherein generating the blueprint comprises:
selecting a predefined blueprint including one or more templates from a set of predefined blueprints; and
editing the one or more templates to include the one or more roll-up shapes.

6. The computer-implemented method of claim 5, wherein generating the blueprint further comprises:
obtaining external data from external sources; and
injecting the external data into the one or more templates.

7. The computer-implemented method of claim 1, wherein the one or more roll-up shapes include input fields configured to receive data.

8. The computer-implemented method of claim 1, wherein the one or more roll-up shapes include corresponding visual activities.

9. The computer-implemented method of claim 1, wherein the one or more roll-up shapes are configured to receive numerical data.

10. The computer-implemented method of claim 9, wherein the insights include an average value of the numerical data for each team of the plurality of teams.

11. The computer-implemented method of claim 1, wherein the one or more roll-up shapes are configured to receive text data.

12. The computer-implemented method of claim 1, further comprising generating the insights, wherein generating the insights include summarizing the user inputs using an artificial intelligence (AI) model.

13. The computer-implemented method of claim 1, further comprising:
determining one or more suggested actions based on the insights; and
sending a notification that includes the one or more suggested actions to management of the organization.

14. The computer-implemented method of claim 1, wherein aggregating the user inputs to generate the insights related to the plurality of teams of the organization comprises:
aggregating the user inputs at a team level, the insights generated for each team of the plurality of teams; and
aggregating the user inputs at a blueprint level, the insights generated for the blueprint.

15. The computer-implemented method of claim 1, further comprising, prior to aggregating the user inputs to generate the insights related to the plurality of teams of the organization, filtering the user inputs to identify information useful for management of the organization.

16. The computer-implemented method of claim 1, wherein usage of the blueprint is continuously monitored to identify different instances the usage of the blueprint.

17. The computer-implemented method of claim 16, wherein the insights include changes in the user inputs over time with respect to the one or more roll-up shapes over the different instances of the blueprint.

18. The computer-implemented method of claim 1, further comprising:
receiving, from the plurality of teams, updated user inputs via the one or more roll-up shapes;
aggregating the updated user inputs to generate updated insights related to the plurality of teams of the organization; and
identifying differences between the insights and the updated insights.

19. A non-transitory computer-readable medium having computer-readable instructions stored thereon that are executable by a processor to perform or control performance of operations comprising:
providing a blueprint to a plurality of teams of an organization, the blueprint including one or more roll-up shapes soliciting user inputs;
receiving, from the plurality of teams, the user inputs via the one or more roll-up shapes; and
aggregating the user inputs to generate insights related to the plurality of teams of the organization.

20. The non-transitory computer-readable medium of claim 18, wherein the operations further comprises:
prior to providing the blueprint to the plurality of teams of the organization:
generating the blueprint.
